(19) United States
(12) Patent Application Publication
(10) Pub. No.: US 2014/0126211 A1
(43) Pub. Date: May 8, 2014

(54) STRUCTURE OF CHRISTMAS LAMP

(71) Applicant: Cheng-Yao CHIANG, Hsinchu City (TW)

(72) Inventor: Cheng-Yao CHIANG, Hsinchu City (TW)

(21) Appl. No.: 13/668,330

(22) Filed: Nov. 5, 2012

(51) Int. Cl. F21V 21/008

(52) U.S. Cl. 362/249.16

(57) ABSTRACT

An LED Christmas lamp string includes a lamp base that has a bottom end receiving lamp string conductor wires to extend therein and covered by a bottom lid. The lamp string conductor wires form four segments inside the lamp base to respectively connect to terminal pieces. A circuit component board has an upper surface to which light-emitting elements and four circuit pins are mounted and a lower surface to which a control IC is mounted. The circuit component board is positioned on a socket to allow the circuit pins to extend through the socket to be bent to attach to projecting blocks of the socket. The socket is fit into the lamp base to have the circuit pins engage the terminal pieces for electrical connection. A light-transmitting cover is then set to cover the circuit component board. A decoration cap is fit to and coupled to the lamp base.

### TECHNICAL FIELD OF THE INVENTION

The present invention generally relates to an improved structure of LED Christmas lamp, and more particularly to an improvement of an individual lamp unit of a Christmas lamp string.

### DESCRIPTION OF THE PRIOR ART

The term “Christmas lamp string” used herein is referred to a type of lamp string that twinkles and flashes and comprises individual light sources made up of LED. The twinkling of Christmas lamp strings can be of two types, one being simply twinkling between light and dark and the other being alternately twinkling among various color lights. For LED Christmas lamp strings, those capable of switching among various color lights would definitely be the main stream of market. Heretofore, the color alternate twinkling function of this type of LED lamp string is controlled by a control box mounted to the lamp string and the control is effected by conductor wires extending from the control box and connected to each light source of the lamp string with two contact terminals that form a circuit. The control case contains therein an integrated circuit, in which a twinkling pattern is loaded so that the entire lamp string will be controlled to do the same pattern of color light twinkling. Such twinkling operation is remarkable. However, in view of the functionality of light emission of LED light sources, it would be possible to further upgrade the alternate color twinkling of the lights. Thus, the present invention aims to further improve the LED Christmas lamp string.

### SUMMARY OF THE INVENTION

The primary object of the present invention is to provide an improved structure of Christmas lamp string that is embodied in an LED Christmas lamp string that is capable of a twinkling effect of alternating and switching of various color lights, whereby each lamp of the LED lamp string is operated in an individual and independent pattern of twinkling for alternating and switching among various color lights so as to provide the LED lamp string with diversified twinkling effect of color changing.

An LED Christmas lamp string according to the present invention that achieves the above object comprises a lamp base, a decoration cap, a bottom lid, a socket, a circuit component board, and a light-transmitting cover. The lamp base has a bottom end that receives lamp string conductor wires to extend therein and is covered by the bottom lid to form a secured connection. The lamp string conductor wires are arranged to form four segments inside the lamp base to respectively connect to terminal pieces. The circuit component board has an upper surface to which light-emitting elements and necessary wiring and four circuit pins are mounted and a lower surface to which a control IC is mounted. The circuit component board is positioned on an upper surface of the socket to allow the four circuit pins to extend through the socket to be bent to attach to projecting blocks formed on four corners of the socket. The socket is then fit into the lamp base to have the four circuit pins respectively engage the four terminal pieces for electrical connection. Then, the light-transmitting cover is put in to cover the circuit component board. Finally, the decoration cap is fit to and coupled to the lamp base to form an LED Christmas lamp string having a function of independently variable twinkling.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side elevational view, in an exploded form, of the present invention.

FIG. 2 is a perspective view, also in an exploded form, of constituent components of the present invention;

FIG. 3 is a perspective view illustrating a decoration cap mounted to a lamp base of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

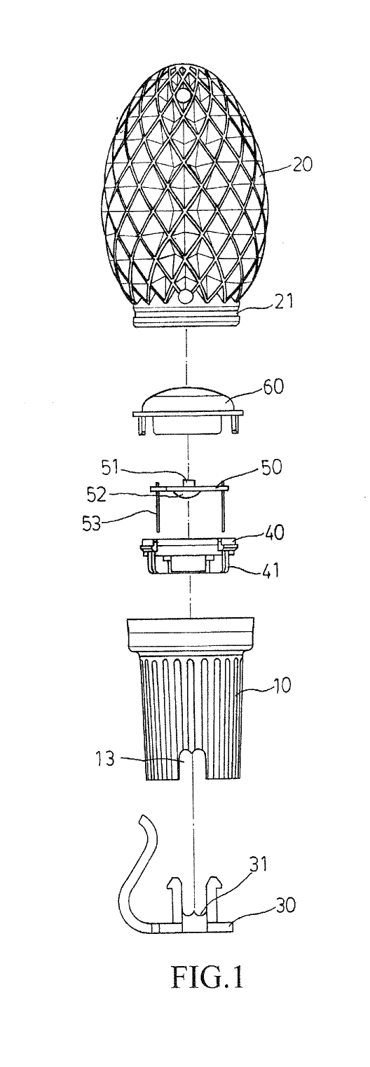

Referring to FIGS. 1-3, the present invention comprises a lamp base (10), a decoration cap (20), a bottom lid (30), a socket (40), a circuit component board (50), and a light-transmitting cover (60) and is mounted to lamp string conductor wires (70). The lamp base (10) forms an interior space, which has four sides to each of which a socket receiving seat (11) is mounted and forms a retention flange (12) at a location adjacent to a top end thereof and a wire channel (13) at the bottom end. The decoration cap (20) is mounted to and covers the top end of the lamp base (10) and is of a hollow configuration that forms a retention groove (21) at a bottom end to engage and thus couple to the retention flange (12) formed in the interior space of the lamp base (10). The decoration cap (20) has an outside surface forming a number of multi-cornered raised/recessed reflection facets. The bottom lid (30) is mounted to and covers the bottom end of the lamp base (10) and has an upper surface forming a positioning slot (31) corresponding in shape and position to the wire channel (13) of the lamp base (10) in order to interpose and fix the lamp string conductor wires (70) to the bottom end of the lamp base (10). The socket (40) is set inside the top end of the lamp base (10) and has an outer periphery forming projecting blocks (41) at locations corresponding to the four socket receiving seats (11) of the lamp base (10). The circuit component board (50) is set on a top of the socket (40) and has an upper surface to which light-emitting elements (51) and other necessary electronic components and wiring are mounted and a lower surface to which a control IC (52) is mounted. The wiring of the board is provided with circuit pins (53) at four corners of the board to extend beyond the lower surface of the board. The circuit pins (53) are respectively fit into the projecting blocks (41) of the socket (40) and further extend beyond the projecting blocks (41) and are exposed and bent to comply with outside surfaces of the projecting blocks (41). The light-transmitting cover (60) is set in the top end of the lamp base (10) and covers the socket (40). The lamp string conductor wires (70) are arranged to form four segments inside the lamp base (10) to respectively connect to terminal pieces (71) that are respectively mounted in the socket receiving seats (11).

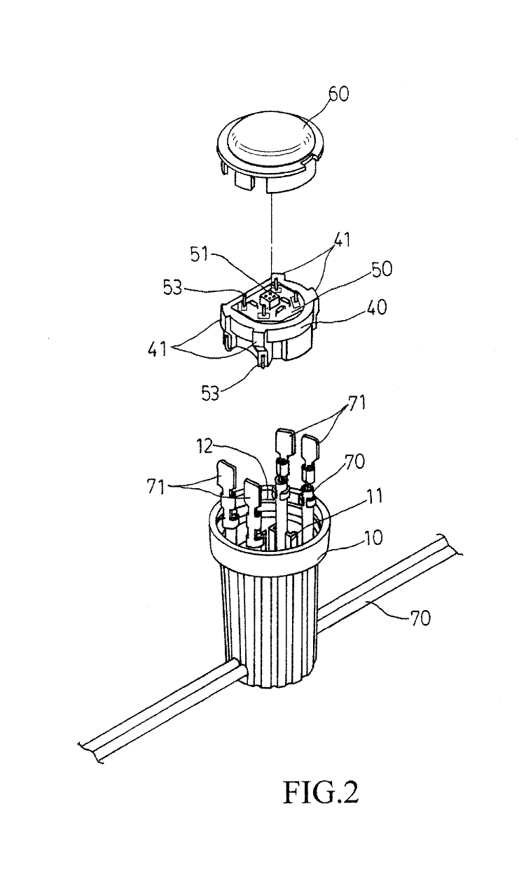

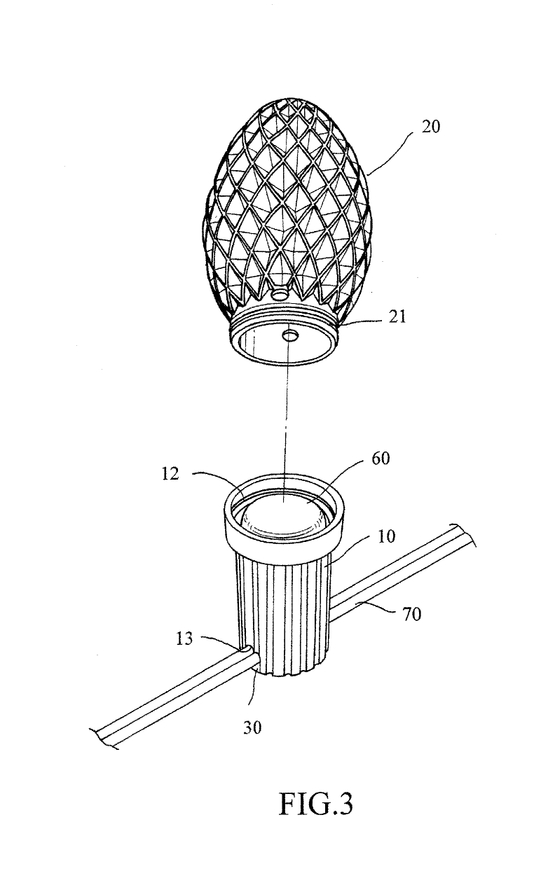

Referring to FIGS. 2 and 3, the bottom end of the lamp base (10) receives the lamp string conductor wires (70) to extend therein and is then covered by the bottom lid (30) to form a secured connection. The circuit component board (50) is positioned on the upper surface of the socket (40) to allow the four circuit pins (53) to extend through the socket (40) and then the circuit pins are bent to attach to the projecting blocks (41) on the four corners of the socket (40). The socket (40) is then fit into the lamp base (10) to have the four circuit pins (53) respectively engage the terminal pieces (71) of the four socket receiving seat (11) for electrical connection. Afterwards, the light-transmitting cover (60) is put in to cover the circuit component board (50). Finally, the decoration cap (20) is fit to the lamp base (10) and coupled thereto by means of the engagement between the retention flange (12) and the retention groove (21). With such a structure of lamp, in a lamp string, each LED lamp can be set in any one of a number of different color changing and twinkling patterns by the individual and independent control IC (52). Further, the electrical connection effected with the four circuit pins (53) of the circuit component board (50) engaging the four terminal pieces (71) of the lamp string conductor wires (70) allows the control box of the lamp string to effect transmission of instruction for activation and change of twinkling of the LED lamp. As such, each of the LED lamps of the entire lamp string can be operated independently to realize an amazing and fantastic changing and twinkling effect.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An LED Christmas lamp string, which comprises a lamp base, a decoration cap, a bottom lid, a socket, a circuit component board, and a light-transmitting cover and is mounted to lamp string conductor wires, the lamp base forming an interior space, which has four sides to each of which a socket receiving seat is mounted, the lamp base having a bottom end that receives the lamp string conductor wires to extend therein and is covered by the bottom lid to form a secured connection, the lamp string conductor wires being arranged to form four segments inside the lamp base to respectively connect to terminal pieces and respectively mounted in the socket receiving seats, the circuit component board having an upper surface to which light-emitting elements and necessary wiring and four circuit pins are mounted and a lower surface to which a control IC is mounted, the circuit component board being positioned on an upper surface of the socket to allow the four circuit pins to extend through the socket to be bent to attach to projecting blocks formed on four corners of the socket, the socket being then fit into the lamp base to have the four circuit pins respectively engage the four terminal pieces for electrical connection, then the light-transmitting cover being put in to cover the circuit component board, the decoration cap being then fit to and coupled to the lamp base to form an LED Christmas lamp string having a function of independently variable twinkling.

2. The LED Christmas lamp string according to claim 1, wherein the lamp base forms a retention flange at a location adjacent to a top end thereof and the decoration cap is of a hollow configuration that forms a retention groove at a bottom end thereof, which engages and couples to the retention flange of the lamp base when the decoration cap is set in and covers the top end of the lamp base.

3. The LED Christmas lamp string according to claim 1, wherein the lamp base forms a retention groove at a location adjacent to a top end thereof and the decoration cap is of a hollow configuration that forms a retention rim at a bottom end thereof, which engages and couples to the retention groove of the lamp base when the decoration cap is set in and covers the top end of the lamp base.
